(19) United States
(12) Patent Application Publication
(10) Pub. No.: US 2014/0321672 A1
(43) Pub. Date: Oct. 30, 2014

(54) ELECTRONIC DEVICE WITH SPEAKERPHONE AND MICROPHONE

(71) Applicant: WINTEK CORPORATION, Taichung City (TW)

(72) Inventors: Chia-Hung Yeh, Taichung City (TW); Shyh-Jeng Chen, Taichung City (TW); Yu-Liang Chow, Taoyuan City (TW); Chia-Wei Chang, Taichung City (TW); Tsung-Yi Lin, Taichung City (TW); Ming-Chuan Lin, Taichung City (TW); Wen-Hung Wang, Taichung City (TW); Shih-Cheng Wang, Changhua County (TW); Hsuan Wang, Kaohsiung City (TW); Chung-Shun Feng, Taipei City (TW); Kuang-Neng Chen, Taichung City (TW); Yin-Zung Wu, Taichung City (TW)

(73) Assignee: WINTEK CORPORATION, Taichung City (TW)

(21) Appl. No.: 14/264,087

(22) Filed: Apr. 29, 2014

(30) Foreign Application Priority Data
Apr. 30, 2013 (TW) 102115490

(51) Int. Cl. H04R 1/02; H04R 1/08

(52) U.S. Cl. CPC H04R 1/02; H04R 1/08
USPC 381/119

(57) ABSTRACT

An electronic device with speakerphone and microphone is provided. The electronic device comprises a housing, a sound input unit, a sound output unit, an audio signal receiving terminal, an acoustic processing unit, a signal line and a sealing member. The housing has a microphone shell, a speaker shell and a soundproof structure. The soundproof structure is connected between the microphone shell and the speaker shell. The soundproof structure has a line output hole. The acoustic processing unit connects the sound input unit and the audio signal receiving terminal respectively to receive and mix two audio signals so as to generate an audio output signal. The audio output signal is transmitted to the sound output unit through a signal line. The sealing member is disposed around the line output hole and seals the line output hole.

This application claims the benefit of Taiwan application Serial No. 102115490, filed Apr. 30, 2013, the subject matter of which is incorporated herein by reference.

### BACKGROUND OF THE INVENTION

1. Field of the Invention

The invention relates in general to an audio device, and more particularly to an electronic device with speakerphone and microphone.

2. Description of the Related Art

Thanks to the advance and development in network technology, the pop music can be downloaded to computers or mobile phones through the network and broadcasted by using a play software. Therefore, consumers can hum or sing with the melody of the music without going to a karaoke.

An electronic device with singing and playing functions simply broadcasts the sound through an external earphone or a speaker, and the user must hold the microphone with one hand when singing a song. If the microphone is too close to the speaker, the microphone may receive the sound broadcasted by the speaker and further amplify the received sound. As a result, ear-piercing echo will be generated. Alternatively, although a software applied to turn on the microphone and broadcast the received sound through the speaker is available and no extra hardware is required, the software will force the microphone to collect sound. As a result, the broadcasted sound will be mixed with environment noises or conversation voices, and the broadcasting quality will deteriorate.

### SUMMARY OF THE INVENTION

The invention is directed to an electronic device with speakerphone and microphone. The electronic device can be inserted into a player with audio in jack for singing or broadcasting the sound.

According to one embodiment of the present invention, an electronic device with speakerphone and microphone is provided. The electronic device comprises a housing, a sound input unit, a sound output unit, an audio signal receiving terminal, an acoustic processing unit, a signal line and a sealing member. The housing has a microphone shell, a speaker shell and a soundproof structure. The soundproof structure is connected between the microphone shell and the speaker shell. The soundproof structure has a line output hole. The sound input unit is disposed inside the microphone shell. The sound output unit is disposed inside the speaker shell. The audio signal receiving terminal is disposed on the housing. The acoustic processing unit connects the sound input unit and the audio signal receiving terminal respectively to receive and mix two audio signals so as to generate an audio output signal. The audio output signal is transmitted to the sound output unit through a signal line. The sealing member is disposed around the line output hole and seals the line output hole.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an appearance diagram of an electronic device with speakerphone and microphone according to an embodiment of the invention.

FIG. 2 is an explosion diagram of an electronic device with speakerphone and microphone according to an embodiment of the invention.

FIG. 3A is an interior diagram of a microphone shell.

FIG. 3B is an interior diagram of a soundproof structure.

FIG. 4 is a block diagram of an acoustic processing unit according to an embodiment.

### DETAILED DESCRIPTION OF THE INVENTION

In the electronic device with speakerphone and microphone of the embodiment, a housing accommodating a speaker and a microphone is combined with a soundproof structure. On one hand, the noises surrounding the sound input unit (such as a microphone) is reduced. On the other hand, the sealing member is attached to the line output hole of the soundproof structure for blocking the resonant sound wave transmitted from the interior of the housing so as to avoid the sound input unit directly receiving a sound wave from the sound output unit (such as a speaker or an amplifier) and reduce echo and noises.

A number of embodiments are disclosed below for elaborating the invention. However, the embodiments of the invention are for detailed descriptions only, not for limiting the scope of protection of the invention.

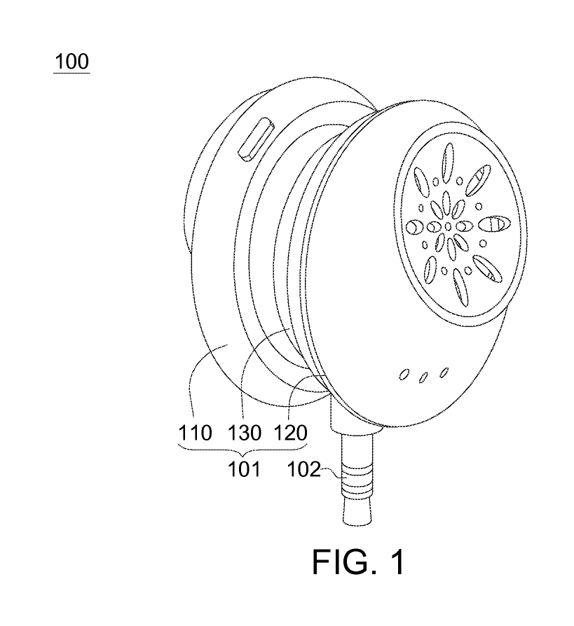

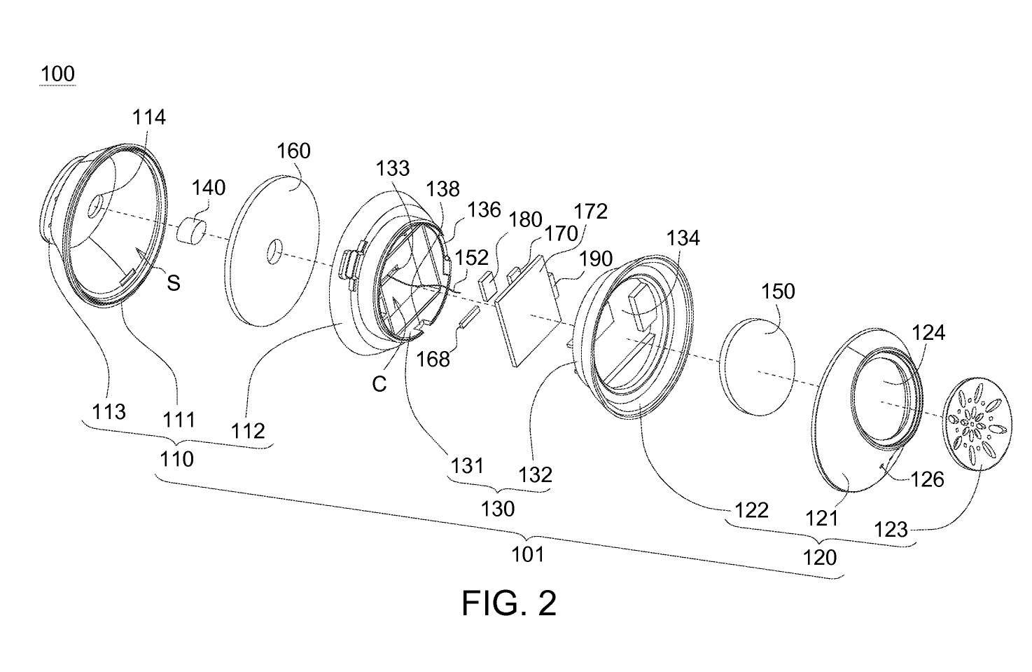

Referring to FIGS. 1 and 2, an appearance diagram and an explosion diagram of an electronic device with speakerphone and microphone according to an embodiment of the invention are respectively shown. As indicated in FIG. 1, the electronic device 100 comprises a housing 101 and an audio signal receiving terminal 102. The housing 101 has a microphone shell 110, a speaker shell 120 and a soundproof structure 130. The audio signal receiving terminal 102 is disposed on the housing 101. The audio signal receiving terminal 102 can be fixed on the soundproof structure 130 through a fixing base 138 (illustrated in FIG. 2) or extended outward through a soft cable (not illustrated). The user only needs to insert the audio signal receiving terminal 102 into any player with audio in jack without using any drive software. The audio in jack may be a 3.5 mm earphone jack. The audio signal receiving terminal 102 may be a 3.5 mm earphone plug.

In another embodiment, the audio signal receiving terminal 102 can receive an audio signal in a wireless manner. For instance, the audio signal receiving terminal 102 is a Bluetooth signal receiving terminal used for receiving a wireless audio signal.

As indicated in FIG. 2, the housing 101 of the electronic device 100 accommodates a sound input unit 140, a sound output unit 150, a signal line 152, an acoustic processing unit 160, a sealing member 168, a switch 170, a battery module 180 and a power connector 190.

The sound input unit 140 and the acoustic processing unit 160 are disposed inside a microphone shell 110 formed by a front housing 111, a rear housing 112 and a perforated plate 113. The sound output unit 150 is disposed inside a speaker shell 120 formed by a front housing 121, a rear housing 122 and a perforated plate 123.

The sound input hole 114 of the microphone shell 110 and the sound output hole 124 of the speaker shell 120 face away from each other, so that the interference by the noises between the sound input unit 140 and the sound output unit 150 can be avoided.

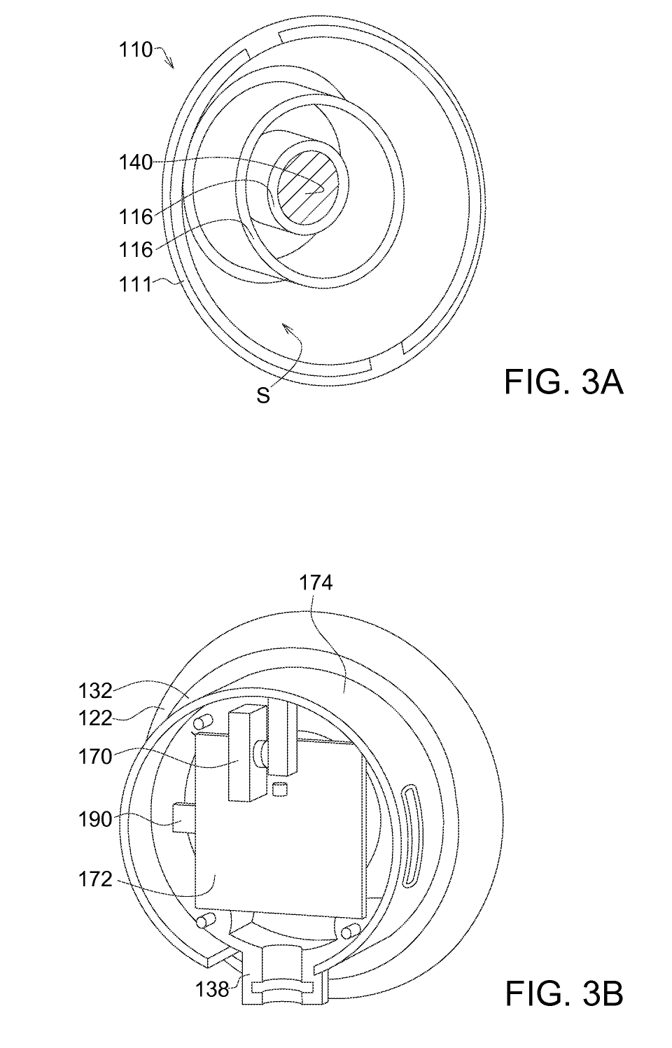

Please refer to FIG. 2 and FIG. 3A. In the accommodation space S of the front housing 111 of the microphone shell 110, the soundproof foam 116 is selectively disposed in the front housing 111 and surrounds the sound input unit 140 so as to reduce the noises surrounding the sound input unit 140 and isolate the interference caused by external and internal noises. As indicated in FIG. 2, the speaker shell 120 further has an air hole 126 capable of improving the frequency response characteristics of the sound output unit 150, such as the frequency response characteristics of the bass sound.

As indicated in FIG. 2, the soundproof structure 130 comprises two soundproof plates 131 and 132 connecting the microphone shell 110 and the speaker shell 120, respectively. The two soundproof plates 131 and 132 are assembled to each other to form an air-proof accommodation space C.

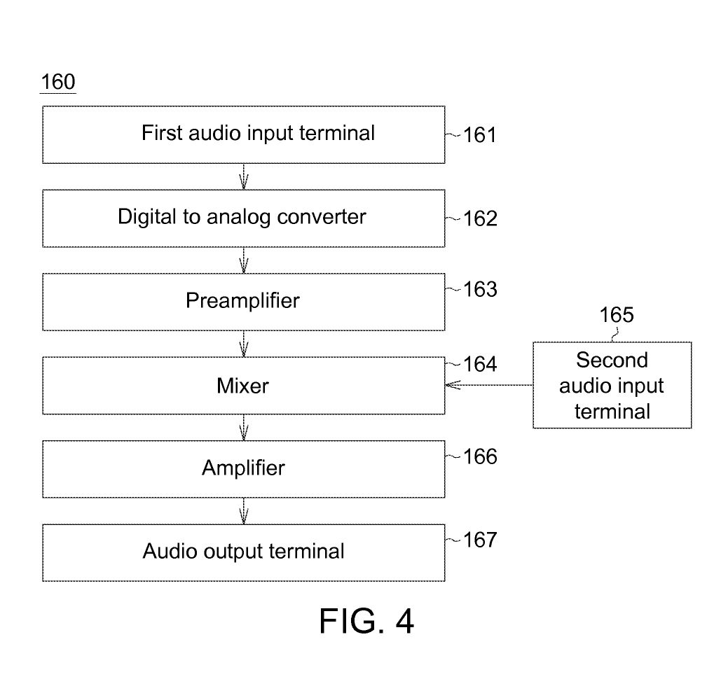

In addition, the switch 170 is disposed inside the accommodation space C formed by the two soundproof plates 131 and 132, and controls the on/off state of the sound input unit 140 and/or the sound output unit 150. As indicated in FIG. 2 and FIG. 3B, a rotation mechanism 174 is selectively disposed on one side of the rear housing 122 adjacent to the switch 170. The switch 170 can be pressed to turn on or off by the rotation mechanism 174. Thus, the switch 170 can control the sound input unit 140 and/or the sound output unit 150. For instance, the sound input unit 140 is a microphone, and the sound output unit 150 is a loudspeaker. After the switch 170 is turned on, the switch 170 electrically connects the sound input unit 140 and the sound output unit 150 through the circuit board 172 and the power is converted into an operating voltage required by the sound input unit 140 and the sound output unit 150. The operating voltage is transmitted to the sound input unit 140 and the sound output unit 150 through respective power cables (not illustrated). The switch 170 of the present embodiment can be a press-type switch, a rotation-type switch or an induction-type switch, and the invention is not limited thereto. Besides, the battery module 180 is disposed inside the accommodation space C formed by the two soundproof plates 131 and 132, and provides a power to the sound input unit 140, the sound output unit 150 and the acoustic processing unit 160. The battery module 180 of the present embodiment can be a charge-type battery such as a lithium battery. The acoustic processing unit 160 comprises a circuit board 172, a signal converter 162, an amplifier 166 and a mixer 164 (see FIG. 4) and electrically connects the sound input unit 140 and the sound output unit 150. The sound input unit 140 receives an audio signal and further transmits the audio signal to the sound output unit 150 through an audio signal line 152. Detailed descriptions are made with reference to FIG. 4.

The power connector 190 can be exposed in an open hole 136 of the soundproof structure 130 for inputting an external power or using the external power to charge the battery module 180. The power connector 190 of the present embodiment can be a universal serial bus (USB) power connector or a power connector with other specifications.

For electrically connecting the sound output unit 150 and the acoustic processing unit 160, the soundproof structure 130 of the present embodiment has at least a line output hole. As indicated in FIG. 2, the soundproof plate 131 disposed on the microphone terminal has a line output hole 133. Besides, the sound input unit 140 and the acoustic processing unit 160 are disposed outside the soundproof plate 131, and the sound output unit 150 is disposed outside another soundproof plate 132. The audio signal line 152, which subsequently passes through the line output hole 133 and the open hole 134 on the soundproof plate 132, can be connected to the sound output unit 150 for transmitting the sound. In another embodiment, the power signal line (not illustrated) of the sound input unit 140 and the acoustic processing unit 160 can be connected to the battery module 180 and the circuit board 172 respectively through the line output hole 133. Furthermore, the soundproof plate 132 can have a suitable aperture (not illustrated) through which the sound output unit 150 can be electrically connected to the switch 170 and the acoustic processing unit 160. The aperture can be sealed to avoid sound leakage.

The soundproof structure 130 of the present embodiment avoids the interference between the sound input unit 140 and the sound output unit 150 when the distance between the sound input unit 140 and the sound output unit 150 is too short. The sealing member 168 is affixed to the line output hole 133 of the soundproof structure 130 and seals the line output hole 133 for blocking a resonant sound wave transmitted from the interior of the housing 101. The sealing member 168 may be formed by foam or rubber, and encapsulates the signal line 152 which passing through the line output hole 133. The signal line 152 is an audio signal line or a power signal line, for example. Thus, the sound input unit 140 will not amplify the sound broadcasted by the sound output unit 150 and will not cause ear-piercing echo.

The processing procedures of the acoustic processing unit 160 which provides the electronic device 100 of the present embodiment with singing and play functions are disclosed below. Referring to FIG. 4, a block diagram of an acoustic processing unit 160 according to an embodiment is shown. The acoustic processing unit 160 comprises a first audio input terminal 161, a digital to analog converter 162, a preamplifier 163, a mixer 164, a second audio input terminal 165, an amplifier 166 and an audio output terminal 167. The digital to analog converter 162 receives a first audio signal, such as human voice, and further converts the first audio signal into an analog signal. The preamplifier 163 is connected to the digital to analog converter 162 for amplifying the analog signal. The mixer 164 connects the preamplifier 163 and second audio input terminal 165 respectively for mixing the first audio signal and the second audio signal. The second audio signal may be a signal of melody, a signal of original singer's voice or a multi-channel signal combining the signals of melody and original singer's voice.

The mixer 164 of the present embodiment can mix the melody, the original singer's voice and the user's voice to obtain an audio output signal. With the audio output signal transmitted to the audio output terminal 167, the user can be guided to sign with the accompaniment of the melody and the original singer's voice so that the electronic device 100 has guide to sing function. Besides, if the signal of original singer's voice is removed and only the signal of melody is transmitted to the mixer 164, then the user can sing with the accompaniment of the melody so that the electronic device 100 has accompaniment function.

Through the sound input unit 140, the user can transmit the user's voice to the first audio input terminal 161, and the melody and/or the original singer's voice can be transmitted to the second audio input terminal 165 through the audio signal receiving terminal 102. Then, the mixer 164 of the acoustic processing unit 160 receives and mixes two audio signals so as to generate an audio output signal. Lastly, the power of the audio output signal is amplified by the amplifier 166, and the amplified audio output signal is transmitted to the sound output unit 150 through the signal line 152 and is played. The process of sound processing finishes here. Moreover, the mixer 164 may comprise an equalizer for filtering off or reducing high frequency noises, so that the tone quality becomes smoother.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device with speakerphone and microphone, comprising:
a housing having a microphone shell, a speaker shell and a soundproof structure, wherein the soundproof structure is connected between the microphone shell and the speaker shell, and the soundproof structure has a line output hole;
a sound input unit disposed inside the microphone shell;
a sound output unit disposed inside the speaker shell;
an audio signal receiving terminal disposed on the housing;
an acoustic processing unit for connecting the sound input unit and the audio signal receiving terminal respectively to receive and mix two audio signals so as to generate an audio output signal;
a signal line for transmitting the audio output signal to the sound output unit; and
a sealing member disposed around the line output hole for sealing the line output hole.

2. The electronic device according to claim 1, wherein the sealing member comprises foam or rubber which seals and is affixed to the soundproof structure.

3. The electronic device according to claim 1, wherein the soundproof structure comprises two soundproof plates connecting the microphone shell and the speaker shell, respectively, and the two soundproof plates are assembled to each other to form an accommodation space.

4. The electronic device according to claim 3, further comprising a switch disposed inside the accommodation space for controlling the sound input unit and/or the sound output unit.

5. The electronic device according to claim 3, further comprising a battery module disposed inside the accommodation space for providing a power to the sound input unit, the sound output unit and the acoustic processing unit.

6. The electronic device according to claim 1, further comprising a power connector exposed in an open hole of the soundproof structure.

7. The electronic device according to claim 6, wherein the power connector comprises a universal serial bus (USB) power connector.

8. The electronic device according to claim 1, further comprising a fixing base disposed on the soundproof structure for fixing the audio signal receiving terminal.

9. The electronic device according to claim 1, wherein the speaker shell has an air hole.

10. The electronic device according to claim 1, wherein the microphone shell has a sound input hole, the speaker shell has a sound output hole, and the sound input hole and the sound output hole face away from each other.
